(19) United States
(12) Patent Application Publication
(10) Pub. No.: US 2022/0125678 A1
(43) Pub. Date: Apr. 28, 2022

(54) TRIGGER POINT ROCKER

(71) Applicant: TRIGGER POINT SYSTEMS, LLC, Irvine, CA (US)

(72) Inventors: Vsevolod MOULER, Irvine, CA (US); Aaron FU, Irvine, CA (US)

(73) Assignee: TRIGGER POINT SYSTEMS, LLC, Irvine, CA (US)

(21) Appl. No.: 17/513,660

(22) Filed: Oct. 28, 2021

Related U.S. Application Data
(60) Provisional application No. 63/106,722, filed on Oct. 28, 2020.

(51) Int. Cl. A61H 39/04; A61H 7/00

(52) U.S. Cl. CPC A61H 39/04; A61H 7/001; A61H 2205/081; A61H 2201/1695; A61H 2201/1623; A61H 2201/1645; A61H 2201/1253

(57) ABSTRACT

A self-massaging tool is provided. The self-massaging tool comprises a first base layer. Further, the self-massaging tool comprises a second layer formed upon the first base layer, wherein the second layer comprises a plurality of rounded protruding structures configured to assert pressure during self-massage of the user, wherein the self-massaging tool has a curved shape providing an outward bulge around its center when the self-massaging tool is aligned with the spine of the user, and wherein the curved shape of the self-massaging tool facilitates a neutral alignment with the spine of the user.

### CROSS REFERENCE TO RELATED APPLICATION(S)

This application claims the benefit of U.S. Provisional Patent Application No. 63/106,722, filed Oct. 28, 2020, which is incorporated by reference herein in its entirety.

### FIELD OF THE INVENTION

The present invention generally relates to the field of self-massaging tools to provide relief from musculoskeletal pain in the neck, shoulders, and lower back.

### BACKGROUND

Myofascial pain syndrome (MPS) is a chronic pain condition affecting the musculoskeletal system. For people with MPS, there are sensitive spots or points known as Myofascial trigger points (MTrPs), also generally known as trigger points. Such points are described as hyperirritable spots in the skeletal muscle. To get relief from MPS, there have been several conventional self-massaging tools available in the market. Conventional self-massaging tools are designed to be utilized for the sole purpose of temporarily reducing musculoskeletal pain. Further, the conventional tools are generally designed to focus only on certain specific spots. Accordingly, for massaging a plurality of spots, a combination of various such tools is required to achieve desired effects.

Accordingly, there exists a need for a method and tool that provides a way to temporarily reduce musculoskeletal pain and reduce the rate of recurrence, all while using just one tool. The present invention seeks to provide such a solution.

### SUMMARY OF THE INVENTION

This summary is provided to introduce a selection of concepts, in a simplified format, that are further described in the detailed description of the invention. This summary is neither intended to identify key or essential inventive concepts of the invention and nor is it intended for determining the scope of the invention.

According to one embodiment of the present invention, a self-messaging tool is disclosed. The self-massaging tool comprises a first base layer. Further, the self-massaging tool comprises a second layer formed upon the first base layer, wherein the second layer comprises a plurality of rounded protruding structures configured to assert pressure on the trigger points during self-massage of the user, wherein the self-massaging tool has a curved shape providing an outward bulge around its center when the self-massaging tool is aligned with the spine of the user, and wherein the curved shape of the self-massaging tool facilitates a neutral alignment with the spine of the user.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIGS. 1A-1C illustrates the self-massaging tool including rounded protruding structures to target a plurality of myofascial trigger points of a user, according to an embodiment of the present invention;

FIG. 2 illustrates a diagonal profile/view of the self-massaging tool, according to an embodiment of the present invention;

FIG. 3 illustrates a side view of the self-massaging tool, according to an embodiment of the present invention;

FIG. 4 illustrates a top view of the second layer of the self-massaging tool, according to an embodiment of the present invention;

FIG. 5 illustrates another side view of the self-massaging tool, according to an embodiment of the present invention;

FIG. 6 illustrates an axial view of the self-massaging tool, according to an embodiment of the present invention; and

FIG. 7 illustrates the reinforced internal structure of the base layer of the self-massaging tool, according to an embodiment of the present invention.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present invention relates to an integrated self-massaging tool comprising a combination of two layers, with the second layer being superimposed or formed on the first layer. The second layer is configured comprises a plurality of rounded protruding structures configured to assert pressure on one or more Myofascial trigger points on neck, shoulders, and back of the user during self-massage. The second layer is configured to be in touch with the user's body, and more specifically with the Myofascial trigger points on user's neck, shoulders, and back. In a preferred embodiment, the self-massaging tool is configured to be used to target the Myofascial trigger points of the user, when the user lies on top of the self-massaging tool with the second layer in touch with user's back. Alternatively, the self-massaging tool may be used while the user is in a sitting or standing posture while massaging his/her back using the self-massaging tool in sitting or standing posture.

While using the self-massaging tool, the user may perform exercises and stretches to emphasize focus on specific Myofascial trigger points areas and to encourage sustained effects. In one embodiment, the self-massaging tool comprises a structurally reinforced acrylonitrile butadiene styrene (ABS) plastic base as the first layer, which provides the structure with durability and support. The ABS plastic or the first layer of the self-massaging tool is formed in a spinal shape for a neutral spine alignment while usage of the tool. The second layer formed on the first layer comprises a plurality of rounded protruding structures configured to assert pressure during self-massage of the user. In an embodiment, the second layer may be made of any synthetic material. In a preferred embodiment, the second layer may be made of ethylene-vinyl acetate (EVA) foam to place deep sustained pressure on the myofascial trigger points.

Using deep sustained pressure and a technique referred to as the “tack-and-stretch,” the present invention encourages the breakdown of scar tissue and improves blood circulation, which increases the oxygen and nutrient supply while facilitating the removal of metabolic byproducts. Further, due to the neutral spine alignment shape, the invention may be used as a back support guide while sitting on chairs.

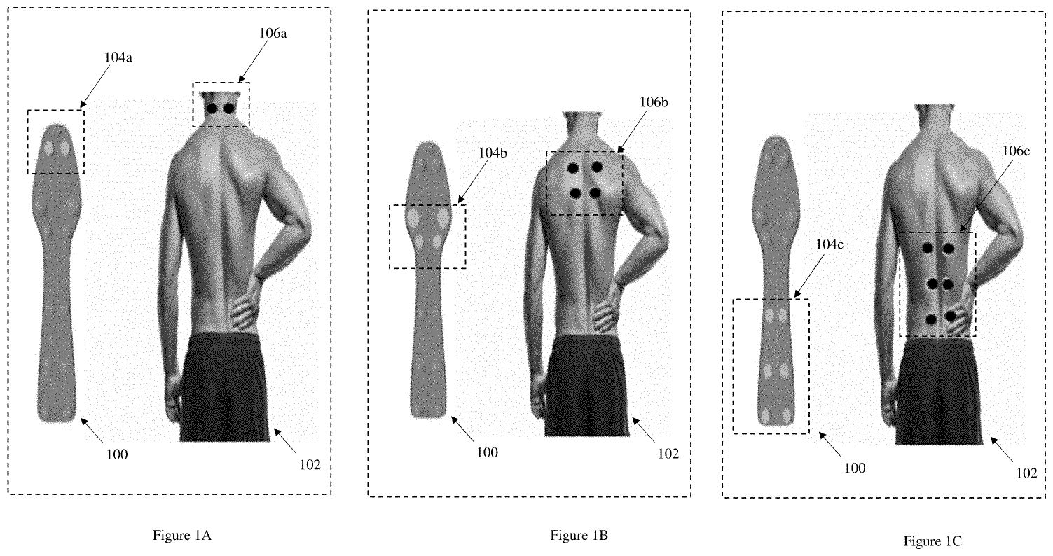

FIGS. 1A-1C illustrates the self-massaging tool 100 including rounded protruding structures 104a-104c to target (or align with) a plurality of myofascial trigger points 106a-106c of a user 102. Each of the FIGS. 1A-1C highlights a different set of rounded protruding structures 104a-104c focusing on a corresponding set of myofascial trigger points 106a-106c of a human being 102. The rounded protruding structures 104a-104c may be in the form of knob shaped elements.

In a preferred embodiment, the self-massaging tool may comprise seven rows of rounded protruding structures, which are outwardly bulging from one layer of the self-massaging tool. The spacing between the protrusions in each row and locations of rounded protruding structures are determined based upon the average distance of the trigger points from the midline of the body/spine. FIG. 1A highlights the first two rows of the self-massaging tool 100. While the first row may include a single outwardly bulging protrusion, the second row may include two outwardly bulging protrusions. The protrusion formed in the first row of the first two rows of protrusions 104a may be configured to support the head of the user 102. In one exemplary embodiment, the dimensions of the rectangular protrusion in the first row may be 28 mm×11.8 mm×10.5 mm. The two protrusions formed in the second row of the first two rows of protrusions 104a may be configured to be aligned with trigger points in the suboccipital muscles of the cervical spine of the user 102. In one exemplary embodiment, the dimensions of each of the two protrusions in the second row may be 30 mm×30 mm×21 mm. Thus, each of the rounded protrusions in the second row may be bigger than the rectangular protrusion of the first row. Additionally, in an exemplary embodiment, the two protrusions of the second row may be separated by a distance of 30 mm.

FIG. 1B highlights the next two rows (middle rows), i.e., the third and fourth rows, of protrusions 104b of the self-massaging tool 100. Each of the third and fourth rows may include two outwardly bulging protrusions. The protrusions formed in the third row of protrusions 104b may be configured to address trigger points in the upper trapezius and levator scapulae of the thoracic spine of the user 102. In one exemplary embodiment, the dimensions of each of the two protrusions in the third row may be 40.5 mm×40.5 mm×18.8 mm. Additionally, in an exemplary embodiment, the two protrusions of the third row may be separated by a distance of 78 mm. Further, the protrusions formed in the fourth row of protrusions 104b may be configured to address trigger points in the rhomboids of the thoracic spine of the user 102. In one exemplary embodiment, the dimensions of each of the two protrusions in the fourth row may be 30 mm×30 mm×14.8 mm. Additionally, in an exemplary embodiment, the two protrusions of the fourth row may be separated by a distance of 41 mm. Thus, while the height of third row protrusions may be greater than fourth row protrusions, the separation distance between the protrusions of third row may also be greater than the separation distance between the fourth row protrusions.

FIG. 1C highlights the next three rows (bottom rows), i.e., the fifth, sixth, and seventh rows, of protrusions 104c of the self-massaging tool 100. Each of the fifth, sixth, and seventh rows may include two outwardly bulging protrusions. The protrusions formed in each of the fifth, sixth, and seventh rows of protrusions 104c may be configured to address the trigger points in the paraspinals of the lumbar spine. In one exemplary embodiment, the dimensions of each of the two protrusions in the fifth row may be 30 mm×30 mm×14.5 mm. Additionally, in an exemplary embodiment, the two protrusions of the fifth row may be separated by a distance of 22 mm. In one exemplary embodiment, the dimensions of each of the two protrusions in the sixth row may be 30 mm×30 mm×11.7 mm. Additionally, in an exemplary embodiment, the two protrusions of the sixth row may be separated by a distance of 33.5 mm. In one exemplary embodiment, the dimensions of each of the two protrusions in the seventh row may be 30 mm×30 mm×15.7 mm. Additionally, in an exemplary embodiment, the two protrusions of the seventh row may be separated by a distance of 52 mm.

According to several embodiments of the present invention, the location of rounded protruding structures 104a-104c may be designed based upon the generic anatomical structure of an average adult human being. The various sizes/heights of rounded protruding structures are designed to allow users of various heights and sizes to target specific areas in neck, shoulders, and back while using the self-massaging tool 100.

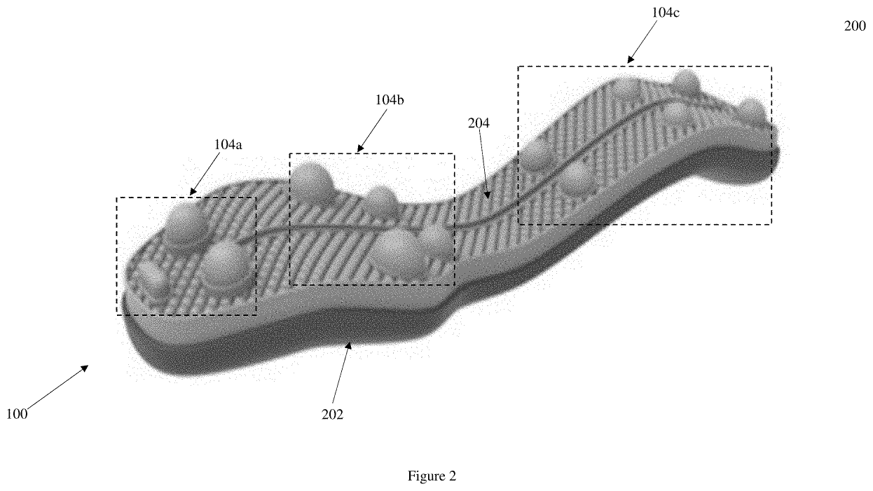

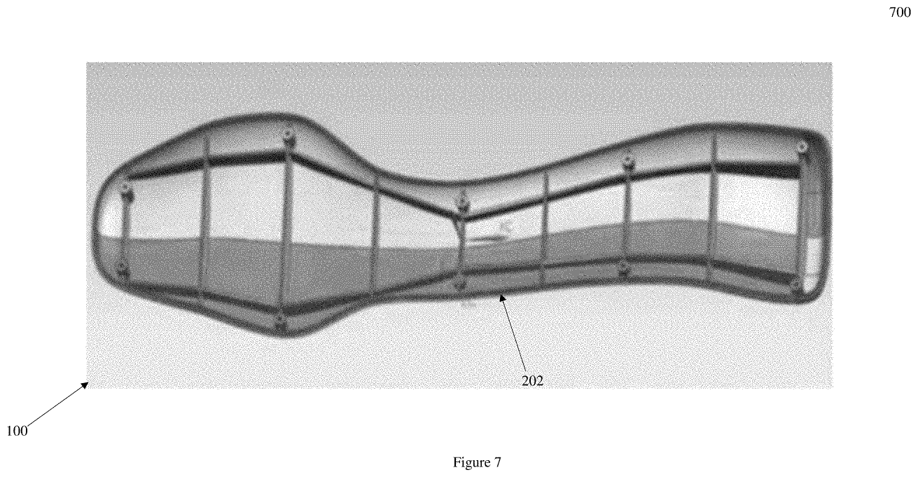

FIG. 2 illustrates a diagonal profile/view 200 of an assembled self-massaging tool 100, according to an embodiment of the present invention. The self-massaging tool 100 may include a first base layer 202, which may include a reinforced internal structure, as depicted in conjunction with FIG. 7. In one embodiment, the first base layer 202 may be made up of acrylonitrile butadiene styrene (ABS) plastic. In another embodiment, the first base layer 202 may be made up of a synthetic material, well known in the art.

Further, the self-massaging tool 100 may include a second top layer 204 formed upon the first base layer. In various embodiments, the second top layer 204 may be coupled to the first base layer using an adhesive or an interlocking mechanism. The second layer 204 may include a plurality of rounded protruding structures 104a-104c to assert pressure on user's body during self-massage by the user. The second layer 204 may be configured to be in touch with user's body (more specifically, the back/spine portion of body) through the plurality of rounded protruding structures 104a-104c. The plurality of rounded protruding structures 104a-104c may be knob shaped elements. In one embodiment, the second layer may be made of ethylene-vinyl acetate (EVA) foam. In another embodiment, the second layer may be made of polyvinyl chloride (PVC) Foam or Thermoplastic elastomer (TPE) foaming. In yet another embodiment, the second layer may be made of a synthetic material well known in the art. In some embodiments, the second layer may include one or more magnets, or an electronic component. Further, the plurality of rounded protruding structures 104a-104c may be made up of same material as the material of second layer 204.

Further, in one embodiment, the self-massaging tool 100 may be a spatula shaped structure configured to have a neutral alignment with spine of an average adult user. Also, as depicted, the self-massaging tool has a curved shape providing an outward bulge around its center when the self-massaging tool is aligned with the spine of the user. In the assembled state, the self massaging tool 100 allows the user to place pressure on specific areas in the neck, shoulders, and lower back while providing the user with the ability to modulate the amount of pressure on the targeted areas. The compact shape of the self-massaging tool 100 also allows users to move their extremities freely so that they may further adjust the amount of pressure on targeted areas and to perform strength and stretch exercises on the self-massaging tool 100 while stimulating the recovery process by breaking up scar tissue and increasing nutrient supply.

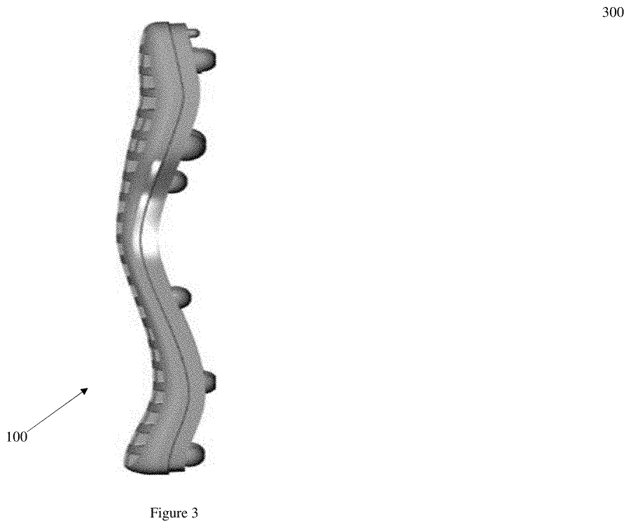

FIG. 3 illustrates a side view 300 of the self-massaging tool 100, according to an embodiment of the present invention. The side view 300 of the self-massaging tool 100 as depicted in FIG. 3, depicts the location, size and height of the protruding structures or treatment knobs that are utilized to target specific trigger points in the neck, shoulders, and lower back. The material provides the user with firm resistance to address the trigger points while also providing enough slack to contort to the user's body. The compression of the material may vary depending upon the user. Heavier users will compress the material more (˜50%) compared to lighter users (˜25%) because of gravity.

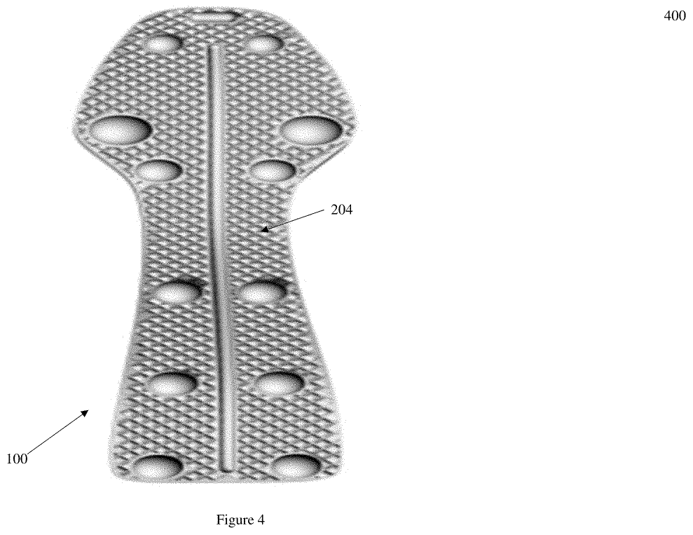

FIG. 4 illustrates a top view 400 of the second layer 204 of the self-massaging tool 100, according to an embodiment of the present invention. The top view 400 of the second layer 204 as depicted in FIG. 4, depicts the two columns or the plurality of rows of protruding structures/treatment knobs, which enable users of various body sizes and shapes to use the self-massaging tool 100 effectively. In particular, the users are able to change their body position while using the invention to target specific areas.

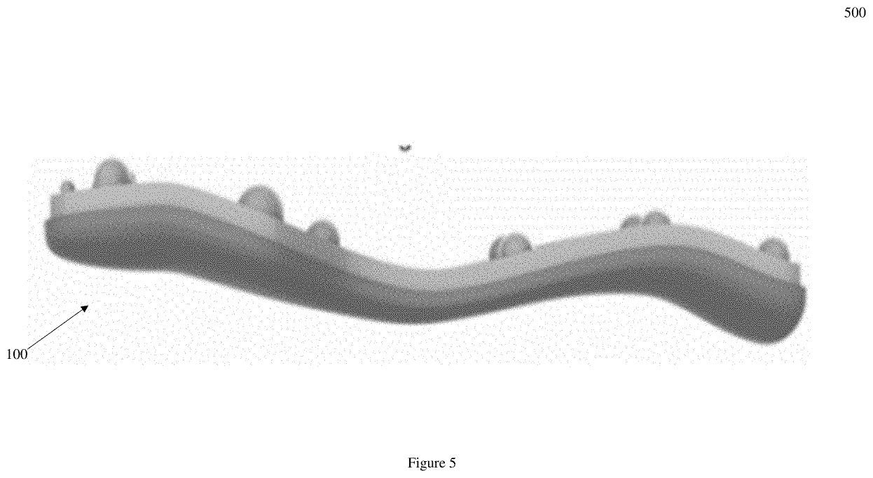

FIG. 5 illustrates another side view 500 of the self-massaging tool 100, according to an embodiment of the present invention. The side view 500 of the self-massaging tool 100 as depicted in FIG. 5, displays the curved shape of the invention that helps to facilitate a neutral alignment of the spine and helps to effectively reduce compression on the intervertebral discs of the spine.

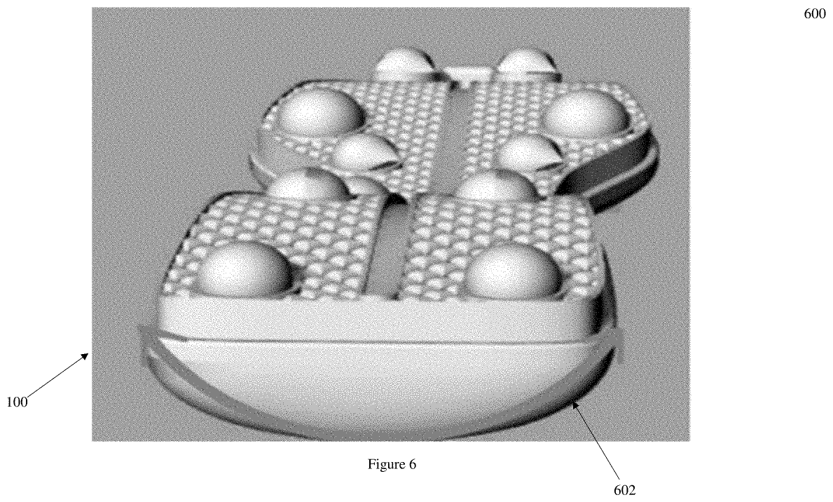

FIG. 6 illustrates an axial view of the self-massaging tool, according to an embodiment of the present invention. The axial view of the self-massaging tool 100 is depicted in FIG. 6. By having a rounded base, it allows the user to rock from side to side and enables them to modulate the amount of pressure placed on each side. By having a rounded base 602, it also encourages the engagement of the abdominal muscles, which helps to stabilize the lumbar spine, and engagement of the gluteals, which helps to stabilize the pelvic girdle.

FIG. 7 illustrates the reinforced internal structure 700 of the base layer of the self-massaging tool 100, according to an embodiment of the present invention. The first base layer 202 may also be designed with a reinforced internal structure as depicted in FIG. 7, which increases the weight capacity of the invention to reduce risk of bending and breaking.

Although the preceding descriptions contain substantial detail and explanation, it should not be construed as limiting the scope of the invention but rather demonstrating the preferred embodiments of the invention. For instance, the exact locations, densities and sizes of the treatment knobs can vary and the exact shape of the first base layer may vary. The aforementioned variations would not materially change the nature of the invention; thus, the scope of the present invention should be based on its main novel nature rather than any specific examples provided.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A self-massaging tool comprising:
a first base layer; and
a second layer formed upon the first base layer, wherein the second layer comprises a plurality of rounded protruding structures configured to assert pressure during self-massage of the user,
wherein the self-massaging tool has a curved shape providing an outward bulge around its center when the self-massaging tool is aligned with the spine of the user, and wherein the curved shape of the self-massaging tool facilitates a neutral alignment with the spine of the user.

2. The self-massaging tool of claim 1, wherein the first base layer comprises a reinforced internal structure.

3. The self-massaging tool of claim 1, wherein the first base layer is made up of acrylonitrile butadiene styrene (ABS) plastic.

4. The self-massaging tool of claim 1, wherein the second layer is made of ethylene-vinyl acetate (EVA) foam.

5. The self-massaging tool of claim 1, wherein the second layer comprises a plurality of rows, each row comprising a least one of the plurality of rounded protruding structures.

6. The self-massaging tool of claim 1, wherein the second top layer is coupled to the first base layer using an adhesive.

7. The self-massaging tool of claim 1, wherein the first base layer includes a rounded base, thereby facilitating engagement of abdominal muscles during massage.

8. The self-massaging tool of claim 1, wherein the self-massaging tool comprises seven rows, each row comprising at least one of the plurality of rounded protruding structures.

9. The self-massaging tool of claim 1, wherein the plurality of rounded protruding structures align with the head, trigger points in the suboccipital muscles of the cervical spine, trigger points in the upper trapezius and levator scapulae of the thoracic spine, trigger points in the rhomboids of the thoracic spine, and trigger points in the paraspinals of the lumbar spine of the user.

10. The self-massaging tool of claim 1, wherein each of the first base layer and the second layer is made of a synthetic material.
